(19) United States
(12) Patent Application Publication
(10) Pub. No.: US 2012/0236460 A1
(43) Pub. Date: Sep. 20, 2012

(54) MULTILAYER CERAMIC CAPACITOR AND METHOD OF MANUFACTURING THE SAME

(75) Inventor: Hyung Joon KIM, Hwaseong (KR)

(73) Assignee: SAMSUNG ELECTRO-MECHANICS CO., LTD.

(21) Appl. No.: 13/229,014

(22) Filed: Sep. 9, 2011

(30) Foreign Application Priority Data
Mar. 14, 2011 (KR) 10-2011-0022179

(51) Int. Cl. H01G 4/30; H01G 4/00

(52) U.S. Cl. 361/301.4; 156/280

(57) ABSTRACT

Disclosed are a multilayer ceramic capacitor and a method of manufacturing the same. According to an exemplary embodiment of the present invention, there is provided a method of manufacturing a multilayer ceramic capacitor, including: preparing a plurality of dielectric layers including a first ceramic powder and a first binder; applying an electrode paste including a conductive powder and a second binder to the plurality of dielectric layers to form a plurality of first inner electrode patterns and second inner electrode patterns exposed to different surfaces of the plurality of dielectric layers; forming a multilayer body by stacking the plurality of dielectric layers; and applying ceramic slurry including a second ceramic powder and a solvent without compatibility with the first binder or the second binder to at least one surface of the multilayer body to form a margin part.

### CROSS-REFERENCE TO RELATED APPLICATIONS

This application claims the priority of Korean Patent Application No. 10-2011-0022179 filed on Mar. 14, 2011, in the Korean Intellectual Property Office, the disclosure of which is incorporated herein by reference.

### BACKGROUND OF THE INVENTION

1. Field of the Invention

The present invention relates to a multilayer ceramic capacitor and a method of manufacturing the same, and more particularly, to a method of manufacturing a multilayer ceramic capacitor with excellent reliability by preventing inner electrode patterns from being short-circuited and a multilayer ceramic capacitor manufactured according to the manufacturing method therefor.

2. Description of the Related Art

A capacitor is an element that stores electricity. In principle, a capacitor may be charged with electricity by applying voltages of opposite polarities to two electrodes. When DC voltage is applied, current flows within a capacitor while electricity is charged, but when charging is complete, current no longer flows. Meanwhile, when AC voltage is applied, AC current continuously flows while alternating the polarity of an electrode.

According to an insulator provided between electrodes, the capacitor may be classified into various types, such as an aluminum electrolytic capacitor having electrodes formed of aluminum and a thin oxide layer provided between the aluminum electrodes, a tantalum capacitor using tantalum as an electrode material, a ceramic capacitor using a high-k dielectric substance, a multilayer ceramic capacitor (MLCC) having a multilayer structure using a high-k ceramic as a dielectric substance provided between electrodes, a film capacitor using a polystyrene film as a dielectric substance between electrodes.

Among others, the multilayer ceramic capacitor has excellent temperature characteristics and frequency characteristics and maybe implemented to have a small size and, as a result, has been widely used for various applications such as a high frequency circuit.

In the multilayer ceramic capacitor according to the related art, a laminate is formed by stacking a plurality of dielectric sheets, outer electrodes having different polarities are formed on the outside of the laminate, and inner electrodes that are alternately stacked in the laminate may be electrically connected each of the outer electrodes.

Recently, as electronic products have been miniaturized and highly integrated, research into the miniaturization and high integration of the multilayer ceramic capacitor has been frequently conducted. In particular, in order to increase the capacity of the multilayer ceramic capacitor and miniaturize the multilayer ceramic capacitor, various attempts at improving the connectivity between the inner electrodes while thinning and highly stacking the dielectric layer have been conducted.

In particular, in order to increase the capacity of the multilayer ceramic capacitor, various attempts at securing the area of the inner electrode patterns in the dielectric layers have been conducted. As the area of the inner electrode patterns occupied by the dielectric layers is expanded, the capacity of the chip is easily secured, but the thickness of margin parts may be reduced, and the inner electrode patterns may be short-circuited.

### SUMMARY OF THE INVENTION

An aspect of the present invention provides a multilayer ceramic capacitor capable of preventing inner electrode patterns from being short-circuited while securing maximal possible coverage to secure capacity in inner electrode patterns and a method of manufacturing the same.

According to an exemplary embodiment of the present invention, there is provided a method of manufacturing a multilayer ceramic capacitor, including: preparing a plurality of dielectric layers including a first ceramic powder and a first binder; applying an electrode paste including a conductive powder and a second binder to the plurality of dielectric layers to form a plurality of first inner electrode patterns and second inner electrode patterns exposed to different surfaces of the plurality of dielectric layers; forming a multilayer body by stacking the plurality of dielectric layers; and applying ceramic slurry including a second ceramic powder and a solvent without compatibility with the first binder or the second binder, to at least one surface of the multilayer body to form a margin part.

The first inner electrode patterns or the second inner electrode patterns maybe applied to cover at least one surface of the dielectric layers so as to contact the margin part.

The margin parts maybe formed to cover surfaces to which all of the first inner electrode patterns and the second inner electrode patterns are exposed.

The first binder or the second binder may be a polar binder.

The first binder or the second binder may be at least one selected from a group consisting of ethyl cellulose and polyvinyl butyral.

The solvent may be a non-polar solvent.

The solvent may be a paraffin-based hydrocarbon.

The method of manufacturing a multilayer ceramic capacitor may further include forming first outer electrodes or second outer electrodes on a surface to which the first inner electrode patterns or the second inner electrode patterns are exposed.

According to another exemplary embodiment of the present invention, there is provided a multilayer ceramic capacitor, including: a multilayer body in which a plurality of dielectric layers having a first ceramic powder and a first binder are stacked; a plurality of first inner electrode patterns and second inner electrode patterns including a conductive powder and a second binder and each formed to be exposed to different surfaces of the plurality of dielectric layers; and a margin part formed on at least one surface of the multilayer body, the margin part including a second ceramic powder and a solvent without compatibility with the first binder or the second binder.

The margin part may be formed by applying a ceramic slurry including the second ceramic powder and the solvent.

The first inner electrode patterns or the second inner electrode patterns maybe applied to cover at least one surface of the dielectric layers so as to contact the margin part.

The margin parts maybe formed to cover surfaces to which all of the first inner electrode patterns and the second inner electrode patterns are exposed.

The first binder or the second binder may be a polar binder.

The first binder or the second binder may be at least one selected from a group consisting of ethyl cellulose and polyvinyl butyral.

The solvent may be a non-polar solvent.

The solvent may be a paraffin-based hydrocarbon.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a multilayer ceramic capacitor according to an exemplary embodiment of the present invention;

FIG. 2 is a cross-sectional view taken along line A-A′ of FIG. 1; and

FIG. 3 is a cross-sectional view taken along line B-B′ of FIG. 1.

### DETAILED DESCRIPTION OF THE PREFERRED EMBODIMENT

Exemplary embodiments of the present invention will now be described in detail with reference to the accompanying drawings. The exemplary embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

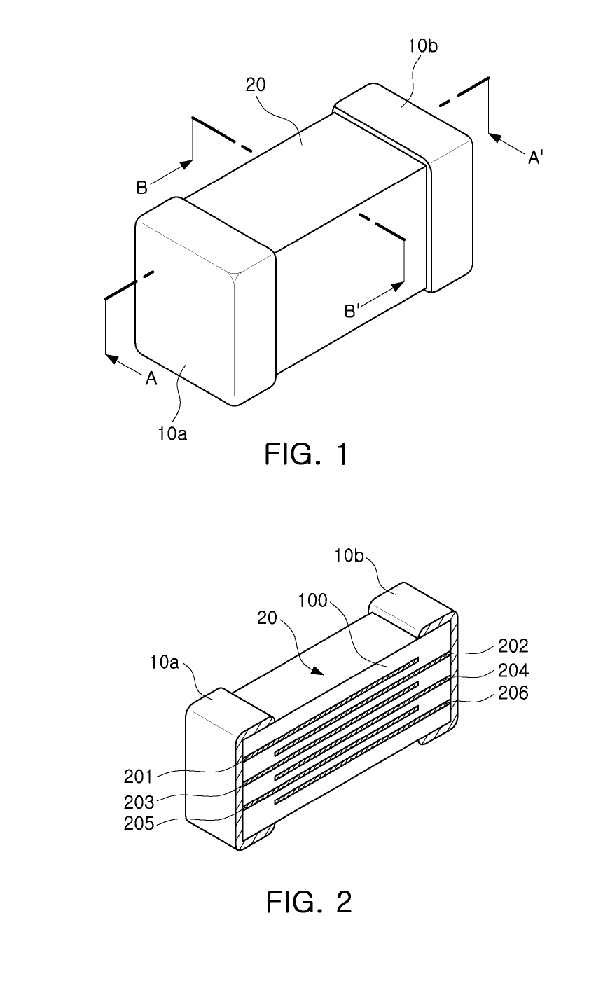

Hereinafter, a multilayer ceramic capacitor according to an exemplary embodiment of the present invention will be described with reference to FIGS. 1 to 3.

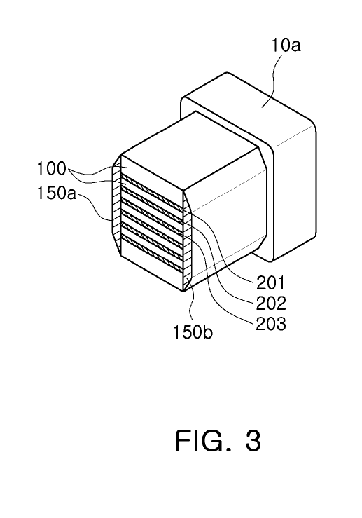

FIG. 1 is a perspective view of the multilayer ceramic capacitor according to the exemplary embodiment of the present invention, FIG. 2 is a cross-sectional view taken along line A-A′ of FIG. 1, and FIG. 3 is a cross-sectional view taken along line B-B′ of FIG. 1.

The multilayer ceramic capacitor according to the exemplary embodiment of the present invention maybe configured to include a multilayer body 20 in which a plurality of dielectric layers are stacked, a first outer electrode 10a and a second outer electrode 10b formed at both ends of the multilayer body.

Referring to FIG. 2, the multilayer body 20 may be configured to include a plurality of dielectric layers 100 and a plurality of first inner electrode patterns 201, 203, and 205 and a plurality of second inner electrode patterns 202, 204, and 206 that are formed in the dielectric layers.

The plurality of dielectric layers may be formed of a high-k ceramic green sheet and then, the multilayer body in which the plurality of dielectric layers are stacked may be formed by stacking and firing processes.

The plurality of dielectric layers may include a first ceramic powder and a first binder. The plurality of dielectric layers maybe formed by applying ceramic slurry on a substrate, but are not limited thereto.

The first ceramic powder is a high-k material. A barium titanate (BaTiO₃)-based material, a lead complex perovskite-based material, strontium titanate (SrTiO₃)-based material, or the like, may be used, preferably, a barium titanate (BaTiO₃) powder may be used, to form the first ceramic powder, but is not limited thereto.

The first binder may be to disperse the first ceramic powder into the ceramic slurry and the dielectric layer may be formed by dispersing the first ceramic powder into the ceramic slurry and applying it in sheet form.

The first outer electrode 10a and the second outer electrode 10b may be formed of a material having excellent electrical conductivity and may serve to electrically connect the first inner electrode patterns 201, 203, and 205 and the second inner electrode patterns 202, 204, and 206 that are formed in the multilayer ceramic capacitor or various patterns according to another exemplary embodiment of the present invention to external devices.

The first outer electrode 10a and the second outer electrode 10b may be charged with different polarities and therefore, the first inner electrode patterns 201, 203, and 205 connected to the first outer electrode 10a and the second inner electrode patterns 202, 204, and 206 connected to the second outer electrode 10b may be charged with different polarities.

The first outer electrode 10a and the second outer electrode 10b are not particularly limited, but may be formed of a conductive material and may be formed of a conductive metal such as Ni, Ag, or Pd.

The first inner electrode patterns 201, 203, and 205 and the second inner electrode patterns 202, 204, and 206 may be formed to be opposed to each other and charged with different polarities, thereby implementing capacity in the capacitor.

In particular, the high-capacity capacitor may be implemented by expanding an overlap area between the first inner electrode patterns 201, 203, and 205 and the second inner electrode patterns 202, 204, and 206.

Although FIGS. 2 and 3 show the case in which the first inner electrode patterns 201, 203, and 205 and the second inner electrode patterns 202, 204, and 206 according to the exemplary embodiment of the present invention are each formed in three layers, but are not limited thereto. In order to implement the high capacity, for example, the dielectric layers maybe highly stacked at levels of 500 layers or more, thereby implementing the high-capacity multilayer ceramic capacitor.

The first inner electrode patterns 201, 203, and 205 and the second inner electrode patterns 202, 204, and 206 according to the exemplary embodiment of the present invention may be formed to cover one surface of the dielectric layer or more in order to secure a maximum possible overlap area.

Referring to FIGS. 2 and 3, the first inner electrode patterns 201, 203, and 205 may be formed to cover a surface of each dielectric layer 100 contacting the first outer electrode 10a and to cover a portion of both surfaces of the first outer electrode adjacent to the surface on which the first outer electrode is formed.

In addition, the second inner electrode patterns 202, 204, and 206 may also be formed to cover a surface of each dielectric layer 100 contacting the second outer electrode 10b and to cover a portion of both sides of the second outer electrode adjacent to the surface on which the second outer electrode 10b is formed.

Therefore, the first inner electrode patterns 201, 203, and 205 may be formed to cover all the areas except for an area spaced apart by a predetermined distance in order to maintain the insulation from the second outer electrode 10b having opposite polarity.

Similarly, the second inner electrode patterns 202, 204, and 206 may be formed to cover all the areas except for an area spaced apart by a predetermined distance in order to maintain the insulation from the first outer electrode 10b having opposite polarity.

Therefore, the first inner electrode patterns 201, 203, and 205 and the second inner electrode patterns 202, 204, and 206 according to the exemplary embodiment of the present invention may secure a maximum possible area in the dielectric layer and may secure a maximum possible overlap area between the first inner electrode patterns 201, 203, and 205 and the second inner electrode patterns 202, 204, and 206.

The first inner electrode patterns 201, 203, and 205 and the second inner electrode patterns 202, 204, and 206 according to the exemplary embodiment of the present invention may be formed to apply the inner electrode paste including a conductive powder and a second binder to the dielectric layer.

The conductive power is to give the inner electrode patterns the electrical conductivity and may be formed of a material having excellent electrical conductivity, and may be formed of at least one selected from a group consisting of Ni, Ag, and Pd, but is not limited thereto.

The first binder and the second binder are to disperse the conductive powder in the inner electrode paste. The inner electrode paste is not particularly limited, but may be printed on the dielectric layer by a printing method such as a screen printing method.

According to the exemplary embodiment of the present invention, as the first binder and second binder, a polarity binder may be used, and ethyl cellulose, polyvinyl butyral and a mixture thereof may also be used, but are not limited thereto.

Further, according to the exemplary embodiment of the present invention, both sides of the inner electrode patterns, which are adjacent to the first outer electrode and the second outer electrode, to which all of the first inner electrode patterns 201, 203, and 205 and the second inner electrode patterns 202, 204, and 206 are exposed, may be provided with margin parts 150a and 150b.

The margin parts 150a and 150b may be formed at the sides to which all of the first inner electrode patterns 201, 203, and 205 and the second inner electrode patterns 202, 204, and 206 are exposed, thereby preventing the plurality of inner electrode patterns from being exposed to the outside and thus being broken and damaged.

According to the exemplary embodiment of the present invention, the margin parts 150a and 150b may include a second ceramic powder and a solvent.

The second ceramic powder may be a material similar to the first ceramic powder and may be formed of a high-k material. Although not particularly limited, as the second ceramic powder, a titanate barium-based material, a lead complex perovskite-based material, strontium titanate-based material, or the like, may be used, although preferably, a barium titanate powder may be used.

The solvent may be to disperse the second ceramic powder, which, according to the exemplary embodiment of the present invention may form the margin parts by applying the ceramic slurry state including the second ceramic powder and the solvent to the side at which the margin parts are formed.

According to the exemplary embodiment of the present invention, the solvent may be to disperse the ceramic powder in the slurry and a non-polar solvent may be used therefor.

According to the exemplary embodiment of the present invention, as the solvent, a material that is not compatible with the first binder or the second binder may be used. While the first binder or the second binder is formed of a polar binder, the solvent may be the non-polar solvent.

Therefore, reactivity between the dielectric layer including the first binder and the inner electrode patterns including the second binder and the margin part may be prevented.

When the solvent is not compatible with the first binder or the second binder, the sheet attack phenomenon between the margin parts and the dielectric layers and the inner electrode patterns may be prevented.

When there is compatibility between the first binder and the solvent, the first binder included in the dielectric layer reacts with the solvent to effuse the ceramic powder together with the first binder, thereby causing a phenomenon in which the inner electrode patterns are short-circuited.

When there is compatibility between the second binder and the solvent, the second binder included in the inner electrode patterns reacts with the solvent in the margin parts to effuse the conductive particles included in the inner electrode patterns into the margin parts together with the second binder, thereby causing a phenomenon in which the adjacent inner electrode patterns are short-circuited.

However, according to the exemplary embodiment of the present invention, the solvent included in the margin parts and the first binder or the second binder included in the inner electrode patterns or the dielectric layers are formed of substances without mutual compatibility, thereby preventing the inner electrode patterns or the dielectric layers from reacting with the margin part and thus preventing the particles from being effused. Therefore, the sheet attack phenomenon in which the inner electrode patterns are short-circuited may be prevented.

According to the exemplary embodiment of the present invention, the solvent may be formed of a material including paraffin-based hydrocarbon. Although not particularly limited, various materials having low compatibility with the first binder or the second binder may be used as the solvent.

According to the exemplary embodiment of the present invention, the maximum possible overlap area between the inner electrode patterns may be secured, thereby allowing for the implementation of a high-capacity multilayer ceramic capacitor and the margin parts having a strong durability and not affecting the multilayer body, and preventing the sheet attack phenomenon of the inner electrode patterns, and thereby manufacturing a highly reliable multilayer ceramic capacitor.

Hereinafter, a method of manufacturing a multilayer ceramic capacitor according to another exemplary embodiment of the present invention will be described below.

The method of manufacturing a multilayer ceramic capacitor according to another exemplary embodiment of the present invention may include preparing a plurality of dielectric layers including a first ceramic powder and a first binder, forming pluralities of first inner electrode patterns and second inner electrode patterns exposed to different surfaces of the plurality of dielectric layers by applying an electrode paste including a conductive powder and a second binder to the plurality of dielectric layers, forming a multilayer body by stacking the plurality of dielectric layers, and forming a margin part by applying ceramic slurry including a second ceramic powder and a solvent without compatibility with the first binder or the second binder to at least one surface of the multilayer body.

In order to manufacture the multilayer ceramic capacitor, the plurality of dielectric layers may be prepared.

The plurality of dielectric layers may be formed by applying a first ceramic slurry including a material including the first ceramic powder and the first binder.

The first ceramic slurry may be applied in the ceramic green sheet shape, and the multilayer body in which the plurality of dielectric layers are stacked by stacking and firing by the plurality of ceramic green sheets, maybe formed.

The inner electrode patterns may be formed by applying the electrode paste including the conductive powder and the second binder to the plurality of dielectric layers. The inner electrode patterns may be formed to be exposed to different surfaces of the plurality of dielectric layers and may include the first inner electrode patterns and the second inner electrode patterns exposed to the opposite surface of the multilayer body according to the exemplary embodiment of the present invention.

The multilayer body may be formed by alternately stacking the plurality of dielectric layers on which the first inner electrode patterns and the second inner electrode patterns are printed so as to alternately stack the first inner electrode patterns and the second inner electrode patterns.

According to the exemplary embodiment of the present invention, the margin part maybe formed by applying the second ceramic slurry including the second ceramic powder and the solvent without compatibility with the first binder or the second binder to at least one surface of the multilayer body.

The margin parts may be formed by applying the second ceramic slurry including the second ceramic powder and the solvent without compatibility with the first binder or the second binder.

The thickness of the margin parts may be controlled according to the amount or frequency of the applied ceramic slurry.

According to the exemplary embodiment of the present invention, as the solvent, a material that is not compatible with the first binder or the second binder may be used. Therefore, the margin parts maybe prevented from reacting with the dielectric layers or the inner electrode patterns, thereby preventing the first ceramic powder or the conductive material from being leaked to the margin parts together with the first binder or the second binder.

That is, the first ceramic powder and the first binder may be prevented from reacting with the solvent of the margin parts so as not to leak the first ceramic powder to the margin part, thereby preventing a phenomenon in which the inner electrode patterns are short-circuited. Further, the phenomenon that the adjacent inner electrode patterns are short-circuited due to the leakage of the conductive material to the margin parts which is caused by the reaction of the conductive material and the second binder with the solvent of the margin parts may be prevented.

Therefore, a phenomenon in which the thinned inner electrode patterns are short-circuited may be prevented, defects of the multilayer ceramic capacitor may be prevented, and reliability may be increased.

According to the exemplary embodiment of the present invention, the first inner electrode patterns or the second inner electrode patterns may be applied to apply at least one surface of the dielectric layer, such that they may be formed to contact the margin part.

The first inner electrode patterns or the second inner electrode patterns may be formed to cover at least one surface of the dielectric layer and may be formed to cover the entire area except for the distance spaced by a predetermined insulating distance from the outer electrode having an opposite polarity in order to maintain the insulation from the outer electrode having opposite polarity.

Therefore, the high-capacity multilayer ceramic capacitor may be implemented by securing a maximum possible area of the inner electrode patterns in the dielectric layers and securing a maximum possible overlap area between the first inner electrode patterns and the second inner electrode patterns.

According to the exemplary embodiment of the present invention, although the first inner electrode patterns or the second inner electrode patterns are formed to cover at least one surface of the dielectric layer, the margin parts may be formed to cover the surfaces to which all of the first inner electrode patterns and the second inner electrode patterns having polarities opposite to each other are exposed.

Therefore, damage and breakage of the inner electrode patterns due to the exposure of the inner electrode patterns to the outside may be prevented while securing a maximum possible area of the inner electrode patterns.

According to the exemplary embodiment of the present invention, the first binder or the second binder may be formed of the polarity binder and the solvent may be formed of non-polar solvent.

Therefore, the phenomenon that the first binder or the second binder reacts with the solvent may be prevented.

In more detail, as the first binder or the second binder, at least one selected from a group consisting of ethyl cellulose and polyvinyl butyral may be used, but is not limited thereto. Therefore, various polar binders known in the art may be used.

In addition, the solvent may include the paraffin-based hydrocarbon. The solvent is not limited thereto and therefore, various non-polar solvents known in the art may be used.

According to the exemplary embodiment of the present invention, the reaction of the dielectric layers and the inner electrode patterns including the first binder or the second binder with the margin parts including the solvent may be prevented, thereby preventing a phenomenon in which the inner electrode patterns are short-circuited.

The method of manufacturing a multilayer ceramic capacitor may further include forming the margin parts in the multilayer body and then, respectively forming the first outer electrode and the second outer electrode on the surfaces of the multilayer body to which the first inner electrode patterns and the second inner electrode patterns are respectively exposed.

The method of manufacturing a multilayer ceramic capacitor according to the exemplary embodiment of the present invention may secure connectivity between the inner electrode patterns and prevent a phenomenon in which the inner electrode patterns are short-circuited, thereby manufacturing the high reliable multilayer ceramic capacitor.

The method of manufacturing a multilayer ceramic capacitor according to the exemplary embodiment of the present invention may secure a maximum possible overlap area between the first inner electrode pattern and the second inner electrode by stably forming the margin parts, thereby providing the high-capacity multilayer ceramic capacitor with high reliability.

As set forth above, according to the exemplary embodiment of the present invention, the sheet attack phenomenon may be removed using materials having relatively low reactivity to each other when forming the inner electrode patterns and the margin parts of the multilayer ceramic capacitor.

Further, according to the exemplary embodiment of the present invention, short-circuits on the surface at which the inner electrode patterns contact the margin parts may be prevented, thereby lowering the rate of defective multilayer ceramic capacitors to improve the reliability of products.

While the present invention has been shown and described in connection with the exemplary embodiments, it will be apparent to those skilled in the art that modifications and variations can be formed without departing from the spirit and scope of the invention as defined by the appended claims.

What is claimed is:

1. A method of manufacturing a multilayer ceramic capacitor, comprising:
preparing a plurality of dielectric layers including a first ceramic powder and a first binder;
applying an electrode paste including a conductive powder and a second binder to the plurality of dielectric layers to form a plurality of first inner electrode patterns and second inner electrode patterns exposed to different surfaces of the plurality of dielectric layers;
forming a multilayer body by stacking the plurality of dielectric layers; and
applying ceramic slurry including a second ceramic powder and a solvent without compatibility with the first binder or the second binder, to at least one surface of the multilayer body to form a margin part.

2. The method of claim 1, wherein the first inner electrode patterns or the second inner electrode patterns are applied to cover at least one surface of the dielectric layers so as to contact the margin part.

3. The method of claim 1, wherein the margin parts are formed to cover surfaces to which all of the first inner electrode patterns and the second inner electrode patterns are exposed.

4. The method of claim 1, wherein the first binder or the second binder is a polar binder.

5. The method of claim 1, wherein the first binder or the second binder is at least one selected from a group consisting of ethyl cellulose and polyvinyl butyral.

6. The method of claim 1, wherein the solvent is a non-polar solvent.

7. The method of claim 1, wherein the solvent is a paraffin-based hydrocarbon.

8. The method of claim 1, further comprising forming first outer electrodes or second outer electrodes on a surface to which the first inner electrode patterns or the second inner electrode patterns are exposed.

9. A multilayer ceramic capacitor, comprising:
a multilayer body including a plurality of stacked dielectric layers having a first ceramic powder and a first binder;
a plurality of first inner electrode patterns and second inner electrode patterns including a conductive powder and a second binder and each formed to be exposed to different surfaces of the plurality of stacked dielectric layers; and
a margin part formed on at least one surface of the multilayer body, the margin part including a second ceramic powder and a solvent without compatibility with the first binder or the second binder.

10. The multilayer ceramic capacitor of claim 9, wherein the margin part is formed by applying ceramic slurry including the second ceramic powder and the solvent.

11. The multilayer ceramic capacitor of claim 9, wherein the first inner electrode patterns or the second inner electrode patterns are applied to cover at least one surface of the dielectric layers so as to contact the margin part.

12. The multilayer ceramic capacitor of claim 9, wherein the margin parts are formed to cover surfaces to which all of the first inner electrode patterns and the second inner electrode patterns are exposed.

13. The multilayer ceramic capacitor of claim 9, wherein the first binder or the second binder is a polar binder.

14. The multilayer ceramic capacitor of claim 9, wherein the first binder or the second binder is at least one selected from a group consisting of ethyl cellulose and polyvinyl butyral.

15. The multilayer ceramic capacitor of claim 9, wherein the solvent is a non-polar solvent.

16. The multilayer ceramic capacitor of claim 9, wherein the solvent is a paraffin-based hydrocarbon.
